(19) United States
(12) Patent Application Publication
(10) Pub. No.: US 2021/0176744 A1
(43) Pub. Date: Jun. 10, 2021

(54) COMMUNICATION APPARATUS AND RADIO COMMUNICATION SYSTEM

(71) Applicant: FUJITSU LIMITED, Kawasaki-shi (JP)

(72) Inventor: AKIRA HIRATA, Yokohama (JP)

(73) Assignee: FUJITSU LIMITED, Kawasaki-shi (JP)

(21) Appl. No.: 17/182,524

(22) Filed: Feb. 23, 2021

Related U.S. Application Data
(63) Continuation of application No. PCT/JP2018/035454, filed on Sep. 25, 2018.

(51) Int. Cl. H04W 72/04; H04W 72/10; H04W 72/12; H04W 16/32; H04W 8/08

(52) U.S. Cl. CPC H04W 72/0406; H04W 72/10; H04W 8/08; H04W 72/1278; H04W 16/32; H04W 72/1242

(57) ABSTRACT

A communication apparatus is configured to perform processing, the processing including: executing an addition processing configured to add identification information for identifying report information to processed report information obtained by performing processing corresponding to a type of the report information on the report information received from a higher-level network; and executing a transmission processing configured to transmit the processed report information to which the identification information is added by the addition unit to a second communication apparatus coupled to a radio link.

### CROSS-REFERENCE TO RELATED APPLICATION

This application is a continuation application of International Application PCT/JP2018/035454 filed on Sep. 25, 2018 and designated the U.S., the entire contents of which are incorporated herein by reference.

### FIELD

The embodiments discussed herein are related to a communication apparatus and a radio communication system.

### BACKGROUND

At present, in the 3rd Generation Partnership Project (3GPP) which is a standardization organization, an element technology of a radio access network that satisfies demand conditions of the fifth generation mobile communication system (5G) has been studied for early introduction of the 5G.

In the 5G mobile network, concentration and distribution of processing in a base station have been studied in order to cope with an increase in message traffic. For example, central unit (CU) and distributed unit (DU) split has been studied as a method of concentrating and distributing the processing in the base station. For example, a next generation Node B (gNB) that is a logical base station is constituted by one combination, a N to 1 combination, or N combinations of the CU and the DU. In the CU and DU split, processing of messages is split for each node in a hierarchy of protocols, a higher-level protocol is processed by the CU, and a lower-level protocol is processed by the DU.

In the gNB, when a Public Warning System (PWS) message such as a Write-Replace Warning Request is received from Access and Mobility Management Function (AMF) of a higher-level apparatus, information for identifying the PWS messages is not notified from the CU to the DU. For example, when the Write-Replace Warning Request is received, the CU aggregates pieces of information into one piece of information such that the DU transmits the message with no change to a radio section. When a PWS Cancel Request is received, the CU deletes the information for identifying the PWS message from the information to be notified to the DU.

Examples of the related art include the following references: [PTL 1] International Publication Pamphlet No. WO 2015/186291; [PTL 2] Japanese Laid-open Patent Publication No. 2012-165197; [PTL 3] Japanese Laid-open Patent Publication No. 2004-274693; [NPL 1] 3GPP TR 38.801 V14.0.0 (2017-03); and [NPL 2] 3GPP TDoc R3-183486 (2018-05).

### SUMMARY

According to an aspect of the embodiments, provided is a communication apparatus configured to perform processing, the processing including: executing an addition processing configured to add identification information for identifying report information to processed report information obtained by performing processing corresponding to a type of the report information on the report information received from a higher-level network; and executing a transmission processing configured to transmit the processed report information to which the identification information is added by the addition unit to a second communication apparatus coupled to a radio link.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a configuration example of a radio communication system according to a first embodiment;

FIG. 2 is a diagram for describing an example of processing of a PWS message in the embodiment;

FIGS. 3A to 3D illustrate a diagram for describing specific examples of the processing of the PWS message in the radio communication system according to the embodiment;

FIG. 4 illustrates an example of a functional configuration of a gNE according to the embodiment;

FIG. 5 illustrates an example of a data configuration of priority information in the embodiment;

FIG. 6 is a diagram for describing a specific example of an operation of a CU in the embodiment;

FIG. 7 is a diagram for describing a specific example of an operation of the gNE in the embodiment;

FIG. 8 illustrates an example of a data configuration of an RRC transmission PWS list in the embodiment;

FIG. 9 is a sequence diagram for describing an example of an operation of the radio communication system in the embodiment;

FIG. 10 is a flowchart for describing an example of an operation of a DU in the embodiment;

FIG. 11 is a flowchart for describing an example of the operation of the DU in the embodiment; and

FIG. 12 illustrates a hardware configuration example of the gNE.

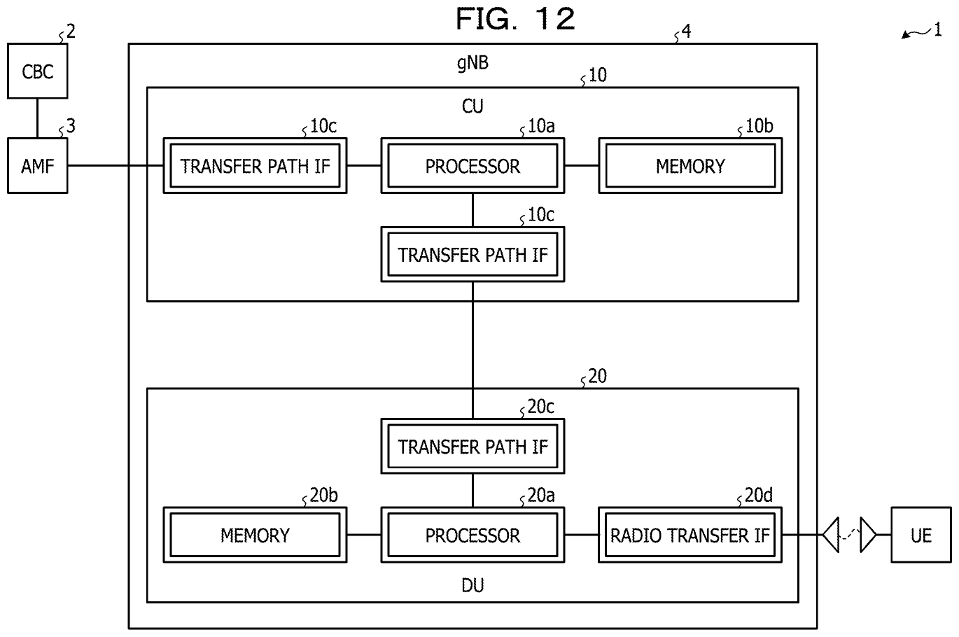

### DESCRIPTION OF EMBODIMENT(S)

Incidentally, when the gNB receives a plurality of PWS messages, it is important that the DU does not transmit information on duplicate PWS messages to the radio section or stops transmission of information on a low-priority PWS message to the radio section according to a resource of the radio section. When an instruction to stop a part of the plurality of PWS messages being received by the gNB is given, it is important that the DU specifies the PWS message to be stopped.

However, when the DU transmits one piece of information aggregated by the CU with no change to the radio section, it is difficult for the DU to perform duplication determination and priority determination of the plurality of PWS messages. It is difficult for the DU to specify the PWS message to be stopped without the information for identifying the PWS message.

An object of a disclosed technology is to provide a communication apparatus and a radio communication system that are capable of identifying and processing a plurality of PWS messages.

Hereinafter, embodiments of a communication apparatus and a radio communication system disclosed in the present application are described in detail with reference to the drawings. The following embodiments are not intended to limit the disclosed technology. Configurations having equivalent functions in the embodiments are denoted by the same reference numerals, and redundant description thereof will be omitted.

### Embodiments

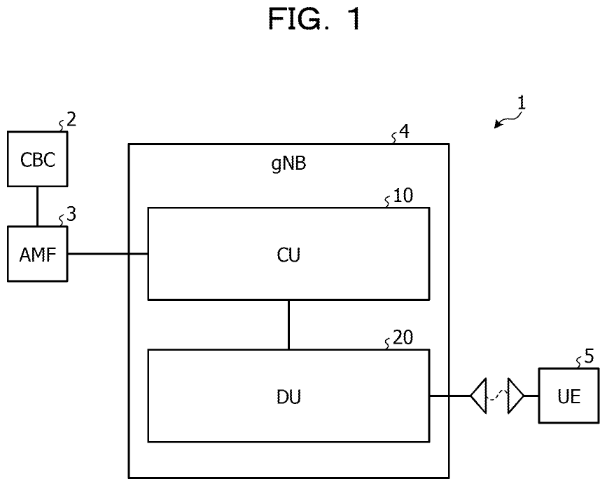

FIG. 1 illustrates a configuration example of a radio communication system 1 according to an embodiment. The radio communication system 1 illustrated in FIG. 1 includes a Cell Broadcast Center (CBC) 2, an AMF 3, a gNB 4, and user equipment (UE) 5. The CBC 2 is a broadcast distribution apparatus that distributes report information such as an Earthquake Early Warning, receives information provided by an information distribution source such as the Weather Management Agency, creates a message, and decides a distribution destination. The AMF 3 controls mobility management, and transmits a PWS message to the gNB 4 in the area.

The gNB 4 is a logical radio base station, and includes a CU 10 and a DU 20. The CU 10 processes a higher-level protocol of a message received from the AMF 3 or the DU 20. In the present embodiment, the CU 10 processes Radio Resource Control (RRC) and Packet Data Convergence Protocol (PDCP). The DU 20 processes a lower-level protocol of a message received from the CU 10 or the UE 5. In the present embodiment, the DU 20 processes Radio Link Control (RLC), Medium Access Control (MAC), and PHYsical layer (PHY). An interface between the CU 10 and the DU 20 is referred to as F1. An interface between the AMF 3 and the CU 10 is referred to as N2.

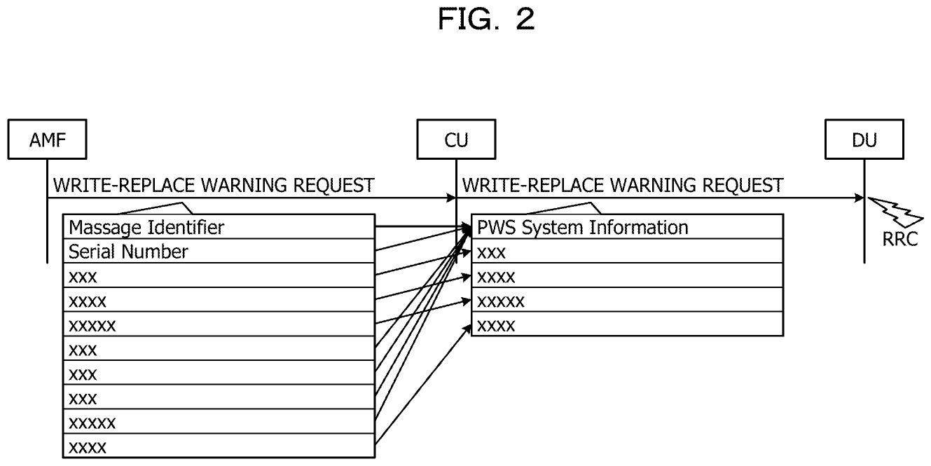

FIG. 2 is a diagram for describing an example of processing of the PWS message in the embodiment. In FIG. 2, a Write-Replace Warning Request is illustrated as the PWS message. A Write-Replace Warning Response, a PWS Cancel Request, a PWS Cancel Response, a PWS Restart Indication, a PWS Failure Indication, and the like are used as other PWS messages.

As illustrated in FIG. 2, in the gNB 4, the CU 10 aggregates pieces of information of the RRC level which include a Message Identifier and a Serial Number among information elements of the Write-Replace Warning Request received from the AMF 3 to PWS System Information. The DU 20 distributes the message to the UE 5 by transmitting the PWS System Information received from the DU 20 with no change to a radio section (see NPL 2).

Here, the Message Identifier is information indicating a message type, and the Serial Number is identification information for identifying a message among messages of the same type. For example, the PWS message may be identified by a combination of the Message Identifier and the Serial Number.

On the other hand, in Long-Term Evolution (LTE) of a 4G standard, a radio base station (eNB) receives a plurality of PWS messages from the Mobility Management Entity (MME) in some cases. For example, an eNB in which S1-Flex coupled in a full mesh is implemented with a plurality of MMEs receives an identical PWS message from different MMEs in some cases. In some cases, the identical PWS message is transmitted from an identical MME by multiple times in order to suppress transmission and reception failures.

When a plurality of identical Write-Replace Warning Requests is received in duplicate, the eNB performs duplication determination by using the combination of the Message Identifier and the Serial Number, and does not transmit the second and subsequent identical messages to the radio section.

When a plurality of different Write-Replace Warning Requests is received, the eNB determines priorities by using the combination of the Message Identifier and the Serial Number, and transmits the messages to the radio section in descending order of priority according to a resource of the radio section.

In contrast, in the radio communication system 1 according to the embodiment, when the gNB 4 receives the plurality of Write-Replace Warning Requests, in the processing illustrated in FIG. 2, since the DU 20 does not know the Message Identifier and the Serial Number, it is difficult to perform the duplication determination and importance determination.

In the radio communication system 1 according to the embodiment, when the gNB 4 receives a PWS Cancel Request for giving an instruction to stop a part of the plurality of Write-Replace Warning Requests while receiving the plurality of Write-Replace Warning Requests, it is important that the DU 20 specifies the PWS message to be stopped.

Thus, in the radio communication system 1 according to the embodiment, as will be described below, the CU 10 includes a PWS identifier for identifying the PWS message such as the Message Identifier or the Serial Number in the PWS message to be transmitted to the DU 20. Accordingly, in the radio communication system 1 according to the embodiment, for example, the DU 20 performs the duplication determination of the plurality of received Write-Replace Warning Requests, and may suppress transmission of an unnecessary message to the radio section. For example, the DU 20 may specify the PWS message to be stopped by the received PWS Cancel Request.

The CU 10 includes an information element (Priority Indicator) for easily determining the priority in the PWS message to be transmitted to the DU 20. Accordingly, for example, the DU 20 determines the priorities of the plurality of received Write-Replace Warning Requests, and may reliably transmit a high-priority message according to the resource of the radio section.

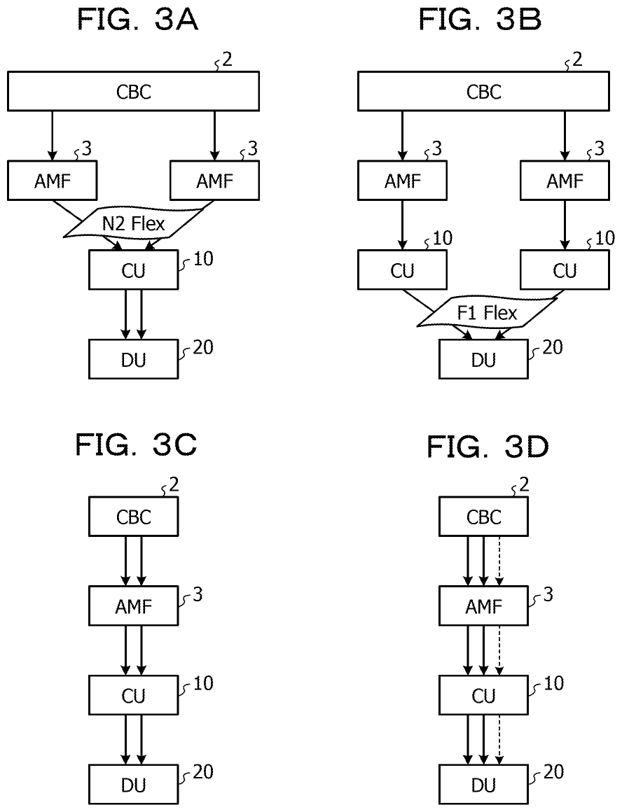

FIG. 3 (i.e. FIGS. 3A to 3D) is a diagram for describing specific examples of processing of the PWS message in the radio communication system 1 according to the embodiment. As illustrated in FIG. 3A, the CU 10 in which N2-Flex is implemented with the AMFs 3 receives the identical PWS messages in duplicate from different AMFs 3 in some cases. As illustrated in FIG. 3B, the DU 20 in which F1-Flex is implemented with the CUs 10 receives the identical PWS message in duplicate from different CUs 10 in some cases. In such a case, the DU 20 may perform the duplication determination by using the PWS identifier.

As illustrated in FIG. 3C, when the plurality of different PWS messages is simultaneously received, the DU 20 may perform the priority determination by using the PWS identifier and the Priority Indicator.

FIG. 3D illustrates a case where the DU 20 further receives the PWS Cancel Request for giving the instruction to stop the transmission of a part of the PWS messages to the radio section while simultaneously receiving the plurality of different PWS messages (Write-Replace Warning Requests). In this case, the DU 20 specifies the message to be stopped by using the PWS identifier included in the PWS Cancel Request received from the CU 10, and may stop the transmission of the message to the radio section.

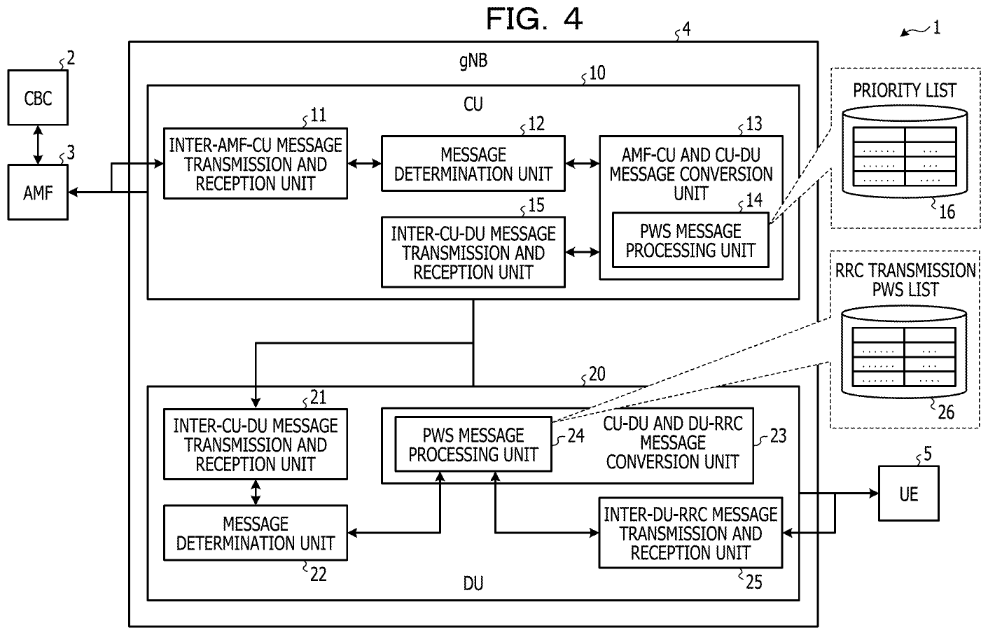

Next, FIG. 4 illustrates an example of a functional configuration of the gNB 4 according to the embodiment. As illustrated in FIG. 4, the gNB 4 includes the CU 10 and the DU 20.

The CU 10 includes an inter-AMF-CU message transmission and reception unit 11, a message determination unit 12, an AMF-CU and CU-DU message conversion unit 13, and an inter-CU-DU message transmission and reception unit 15. The CU 10 stores a priority list 16 in a memory.

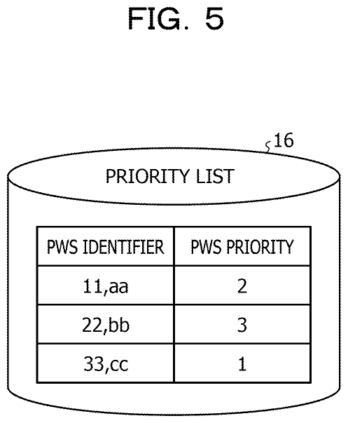

FIG. 5 illustrates an example of a data configuration of the priority list 16. As illustrated in FIG. 5, the priority list 16 is information indicating a correspondence between the PWS identifier and the priority (PWS priority). FIG. 5 illustrates that, for example, a priority of a PWS message with a PWS identifier “11, aa” is “2”. In the example illustrated in FIG. 5, the PWS identifier is represented by the combination of the Message Identifier and the Serial Number of the PWS message. For example, the PWS identifier “11, aa” indicates that the Message Identifier is “11” and the Serial Number is “aa”.

The PWS identifier is not limited to the combination of the Message Identifier and the Serial Number of the PWS message, and may be, for example, a hash value as long as the PWS message may be identified. The priority will be described later.

Referring back to FIG. 4, the description will be continued. The inter-AMF-CU message transmission and reception unit 11 controls communication between the CU 10 and the AMF 3 of a higher-level network. The message determination unit 12 determines the processing corresponding to the message type for each PWS message received from the AMF 3, and delivers the PWS message to be transmitted to the DU 30 to the AMF-CU and CU-DU message conversion unit 13.

The AMF-CU and CU-DU message conversion unit 13 performs the processing corresponding to the message type on the message received from the message determination unit 12. The AMF-CU and CU-DU message conversion unit 13 includes a PWS message processing unit 14.

The PWS message processing unit 14 functions as an addition unit. For example, the PWS message processing unit 14 adds the PWS identifier that is the identification information for identifying the PWS message to the processed PWS message obtained by performing processing corresponding to the message type of the PWS message on the PWS message that is report information received from a higher-level network.

The PWS message processing unit 14 further adds, to the processed PWS message, predetermined priority information for each PWS message which indicates a priority order in which the DU 20 coupled to a radio link transmits the message by using the radio link.

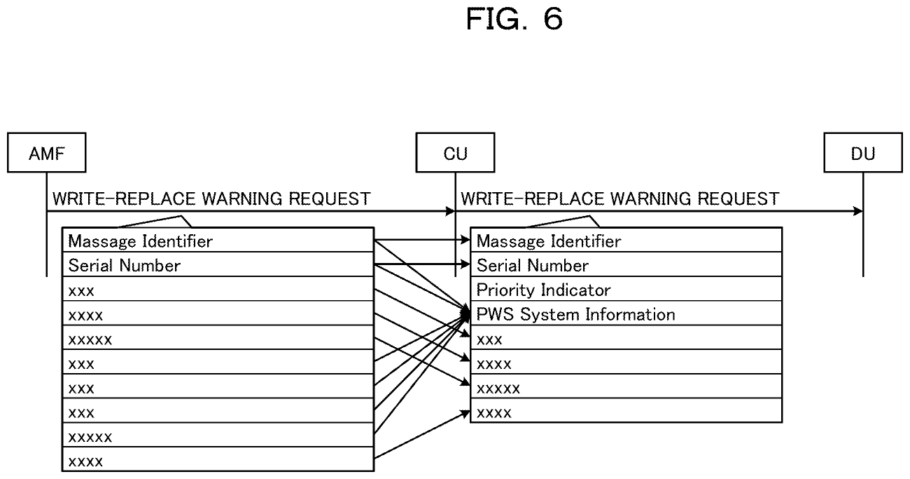

FIG. 6 is a diagram for describing a specific example of an operation of the CU 10 in the embodiment. FIG. 6 illustrates a case where the CU 10 receives the Write-Replace Warning Request as the PWS message from the AMF 3. As illustrated in FIG. 6, in the CU 10, the AMF-CU and CU-DU message conversion unit 13 performs processing specialized for the Write-Replace Warning Request and creates the processed PWS message. For example, the AMF-CU and CU-DU message conversion unit 13 aggregates the pieces of information of the RRC level which includes the Message Identifier and the Serial Number among the information elements of the received Write-Replace Warning Request to the PWS System Information.

The PWS message processing unit 14 adds the Message Identifier and the Serial Number to the processed PWS message. The PWS message processing unit 14 also adds the Priority Indicator as the priority information. The Priority Indicator is the information elements indicating the priority corresponding to the Message Identifier and the Serial Number. The PWS message processing unit 14 specifies the priority corresponding to the Message Identifier and the Serial Number while referring to the priority list 16, and sets a value of the specified priority to the Priority Indicator.

As will be described later, the priority is a value that designates the priority order in which the DU 20 transmits the processed PWS message to the radio link, and is a value set in advance for each PWS message. The CU 10 sets the priority of each PWS message in advance in cooperation with an operation and maintenance (O&M) apparatus or a higher-level apparatus such as the AMF 3, and stores the priority as the priority list 16. As stated above, the priority information is used, and thus, the DU 20 may easily determine the priority as will be described later.

For example, the PWS message processing unit 14 may not add the priority information to the PWS Cancel Request.

The CU 10 negotiates the setting of the priority information in advance with the DU 20. For example, the CU 10 and the DU 20 share a method relating to the set value of the Priority Indicator in advance. For example, the DU 20 designates a method of setting the priority to be notified to the DU to 5 stages, or designates a method of setting the PWS message with a low priority not to be notified. In this case, for example, the CU 10 stores the priority list 16 for each method, and adds the priority information by using the priority list 16 corresponding to the method designated by the DU 20.

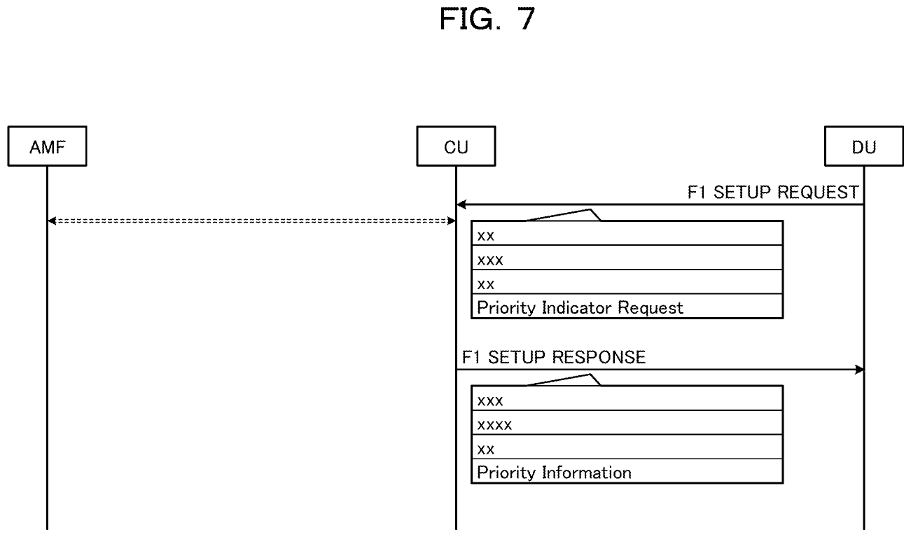

FIG. 7 is a diagram for describing a specific example of an operation of the gNB 4 in the embodiment. FIG. 7 illustrates a case where the CU 10 and the DU 20 negotiate the setting of the priority information by using an F1 Setup Procedure. As illustrated in FIG. 7, the DU 20 adds a Priority Indicator Request to an F1 Setup Request. The Priority Indicator Request is, for example, an information element for designating the above method.

The CU 10 adds the Priority Information to an F1 Setup Response to be returned to the DU 20. The Priority Information is an information element indicating a response to the Priority Indicator Request, and for example, information indicating the decided method is set.

After the F1 Setup Request is received from the DU 20, the CU 10 may set the priority of each PWS message in cooperation with the O&M apparatus or the higher-level apparatus. For example, the CU 10 creates the priority list 16 corresponding to the method designated by the DU 20.

The negotiation on the setting of the priority information between the CU 10 and the DU 20 is not limited to a case of using the F1 Setup Procedure. For example, the negotiation of the setting of the priority information may be performed or changed by using a GNB-DU Configuration Update Procedure between the CU 10 and the DU 20. In this case, the DU 20 adds the Priority Indicator Request to a GNB-DU Configuration Update. The CU 10 adds the Priority Information to a GNB-DU Configuration Acknowledge to be returned to the DU 20. After the GNB-DU Configuration Update is received from the DU 20, the CU 10 may set the priority of each PWS message in cooperation with the O&M apparatus or the higher-level apparatus.

Alternatively, the negotiation of the setting of the priority information may be performed or changed by using a GNB-CU Configuration Update Procedure between the CU 10 and the DU 20. In this case, the CU 10 sets the priority of each PWS message in advance in cooperation with the O&M apparatus or the higher-level apparatus. The CU 10 adds the Priority Indicator Request to a GNB-CU Configuration Update. The DU 20 adds the Priority Information to GNB-CU Configuration Acknowledge to be returned to the CU 10.

Referring back to FIG. 4, the description will be continued. The inter-CU-DU message transmission and reception unit 15 controls communication between the CU 10 and the DU 20. For example, the inter-CU-DU message transmission and reception unit 15 functions as a transmission unit. For example, the inter-CU-DU message transmission and reception unit 15 transmits the processed PWS message to which the PWS identifier is added by the PWS message processing unit 14 to the DU 20 that is another communication apparatus coupled to the radio link.

The DU 20 includes an inter-CU-DU message transmission and reception unit 21, a message determination unit 22, a CU-DU and DU-RRC message conversion unit 23, and an inter-DU-RRC message transmission and reception unit 25. The DU 20 stores an RRC transmission PWS list 26 in a memory.

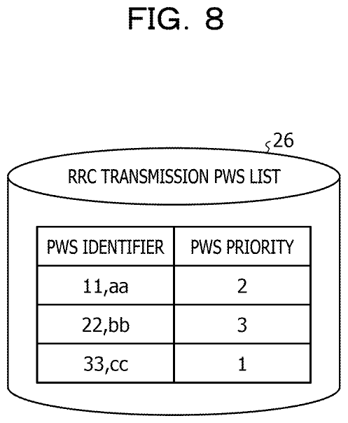

FIG. 8 illustrates an example of a data configuration of the RRC transmission PWS list 26. The RRC transmission PWS list 26 is information for managing the PWS message (Write-Replace Warning Request) being received by the DU 20, and includes the PWS identifier and the PWS priority of the Write-Replace Warning Request being received as illustrated in FIG. 8. For example, FIG. 8 illustrates that the DU 20 is receiving a message with a PWS identifier “11, aa” and a priority “2” as a target to be transmitted to the radio section.

Referring back to FIG. 4, the description will be continued. The inter-CU-DU message transmission and reception unit 21 controls communication between the CU 10 and the DU 20. For example, the inter-CU-DU message transmission and reception unit 21 functions as a reception unit. For example, the inter-CU-DU message transmission and reception unit 21 receives the processed PWS message obtained by adding the PWS identifier for identifying the PWS message to the PWS message transmitted from the higher-level network and performing the processing corresponding to the message type of the PWS message on the PWS message.

The message determination unit 22 determines the processing corresponding to the message type for each processed PWS message received from the CU 10, and delivers the processed PWS message to be transmitted to the radio link to the CU-DU and DU-RRC message conversion unit 23.

The CU-DU and DU-RRC message conversion unit 23 performs the processing corresponding to the message type on the processed PWS message received from the message determination unit 22. The CU-DU and DU-RRC message conversion unit 23 includes a PWS message processing unit 24.

The PWS message processing unit 24 functions as an identification unit. For example, the PWS message processing unit 24 identifies the processed PWS message by using the PWS identifier added to each of the plurality of processed PWS messages received from the CU 10.

For example, the PWS message processing unit 24 identifies the message to be stopped by using the PWS identifier included in the PWS Cancel Request received from the CU 10. Accordingly, for example, when the DU 20 receives the PWS Cancel Request having, as targets, a part of the plurality of different Write-Replace Warning Requests while simultaneously receiving the plurality of different Write-Replace Warning Requests, the DU 20 specifies the message to be stopped, and may stop the transmission of the message to the radio section (see FIG. 3(d)).

The PWS message processing unit 24 performs the duplication determination for controlling the duplicate processed PWS messages among the plurality of received processed PWS messages. For example, the PWS message processing unit 24 determines that the messages of which the PWS identifiers coincide with each other among the plurality of received Write-Replace Warning Requests are duplicated while referring to the RRC transmission PWS list 26. The DU 20 may suppress the transmission of the unnecessary message to the radio section by stopping the transmission of the second and subsequent identical Write-Replace Warning Requests to the radio section.

The PWS message processing unit 24 further performs priority determination processing of controlling the priority order in which the DU transmits the message by using the radio link by using predetermined priority information for each PWS message which is added to the processed PWS message and indicates the priority order in which the DU transmits the message by using the radio link. For example, the PWS message processing unit 24 transmits the messages to the radio section in descending order of priority in a range in which there is an available resource in the radio section by using the value of the Priority Indicator added to each of the plurality of received Write-Replace Warning Requests.

For example, the PWS message processing unit 24 transmits, to the radio section, the messages in descending order of priority among the Write-Replace Warning Requests being received as a target to be transmitted to the radio section while referring to the RRC transmission PWS list 26. When there is no available resource in the radio section, the transmission of a low-priority message is stopped. Accordingly, the DU 20 determines the priority of the PWS message with simple processing, and may reliably transmit the high-priority message to the radio section even when there are a few resources in the radio section.

The PWS message processing unit 24 adds the Message Identifier and the Serial Number to the PWS message to be transmitted to the CU 10. For example, the PWS message processing unit 24 adds the same Message Identifier and Serial Number as the Message Identifier and Serial Number of the PWS message such as the PWS Cancel Request received from the CU 10 to the PWS message as the response such as the PWS Cancel Response to be returned to the CU 10. At this time, the PWS message processing unit 24 may add the Priority Indicator with no change. Neither the Message Identifier, the Serial Number, nor the Priority Indicator may be added to the PWS message indicating a state of a cell such as the PWS Restart Indication.

Referring back to FIG. 4, the description will be continued. The inter-DU-RRC message transmission and reception unit 25 controls communication between the DU 20 and the UE 5. For example, the inter-DU-RRC message transmission and reception unit 25 distributes the message to the UE 5 by transmitting the PWS System Information of the Write-Replace Warning Request to the radio link.

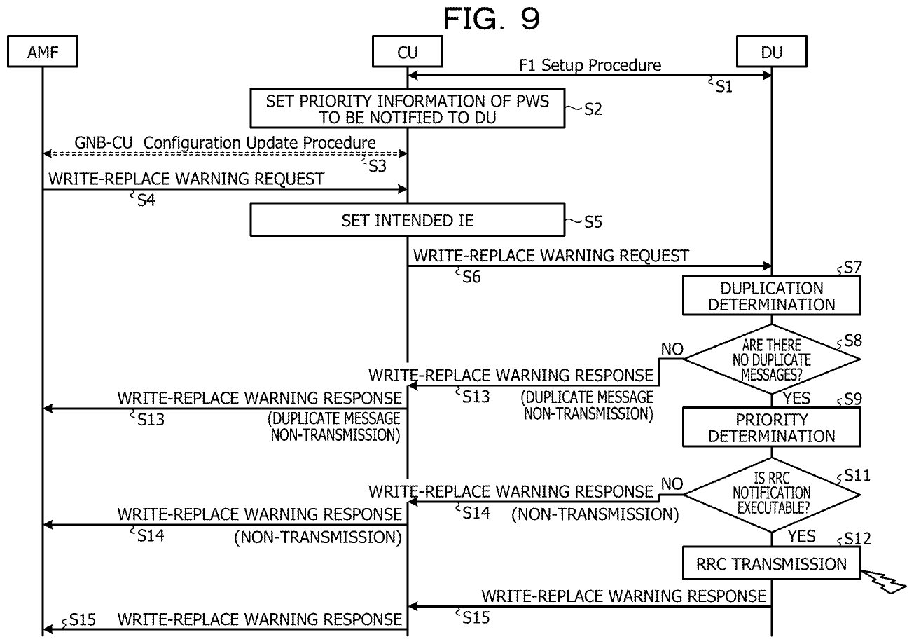

Next, an operation of the radio communication system 1 according to the present embodiment will be described. FIG. 9 is a sequence diagram for describing an example of the operation of the radio communication system 1 according to the embodiment.

First, the CU 10 and the DU 20 negotiate the setting of the priority information by using the F1 Setup Procedure (step S1). The CU 10 creates the priority list 16 for setting the priority information of the PWS to be notified to the DU 20 according to the negotiation (step S2). When the negotiation of the setting of the priority information is changed, the CU 10 uses, for example, the GNB-CU Configuration Update Procedure (step S3).

In the CU 10, when the Write-Replace Warning Request is received from the AMF 3 (step S4), the PWS message processing unit 14 sets an intended information element (IE) (step S5). For example, the PWS message processing unit 14 adds the Message Identifier and the Serial Number to the Write-Replace Warning Request processed by the AMF-CU and CU-DU message conversion unit 13. The PWS message processing unit 14 adds the Priority Indicator as the priority information by using the priority list 16. The inter-CU-DU message transmission and reception unit 15 transmits, to the DU 20, the processed Write-Replace Warning Request to which the intended information element is added (step S6).

In the DU 20, the PWS message processing unit 24 identifies the Write-Replace Warning Request by using the Message Identifier and the Serial Number added to each of the plurality of processed Write-Replace Warning Requests received from the CU 10. First, the PWS message processing unit 24 performs the duplication determination for determining that there are the duplicate messages among the plurality of received processed Write-Replace Warning Requests (step S7).

When it is determined that there are the duplicate messages as a result of the duplication determination (No in step S8), the PWS message processing unit 24 advances the processing to step S13. In the processing of step S13, the PWS message processing unit 24 returns the Write-Replace Warning Response indicating that the message is not transmitted to the radio section due to the duplication to the CU 10 and the AMF 3 via the inter-CU-DU message transmission and reception unit 21 and the CU 10.

On the other hand, when it is determined that there are no duplicate messages as the result of the duplication determination (Yes in step S8), the PWS message processing unit 24 performs the priority determination by using the Priority Indicator added to each of the plurality of received processed Write-Replace Warning Requests (step S9).

When the transmission (RRC notification) of the message to the radio section is not executable as a result of the priority determination (No in step S11), the PWS message processing unit 24 advances the processing to step S14. In the processing of step S14, the PWS message processing unit 24 returns the Write-Replace Warning Response indicating that the message is not transmitted to the radio section due to the low priority to the CU 10 and the AMF 3 via the inter-CU-DU message transmission and reception unit 21 and the CU 10.

On the other hand, when the transmission of the message to the radio section is executable as the result of the priority determination (Yes in step S11), the inter-DU-RRC message transmission and reception unit 25 transmits the PWS System Information of the Write-Replace Warning Request to the radio link (RRC transmission, step S12). The PWS message processing unit 24 advances the processing to step S15. In the processing of step S15, the PWS message processing unit returns the Write-Replace Warning Response indicating that the transmission of the message to the radio section is completed to the CU 10 and the AMF 3 via the inter-CU-DU message transmission and reception unit 21 and the CU 10.

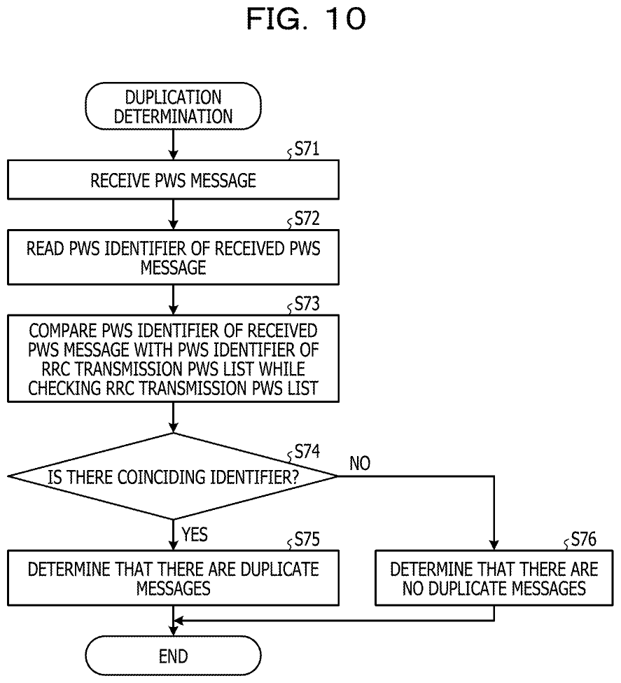

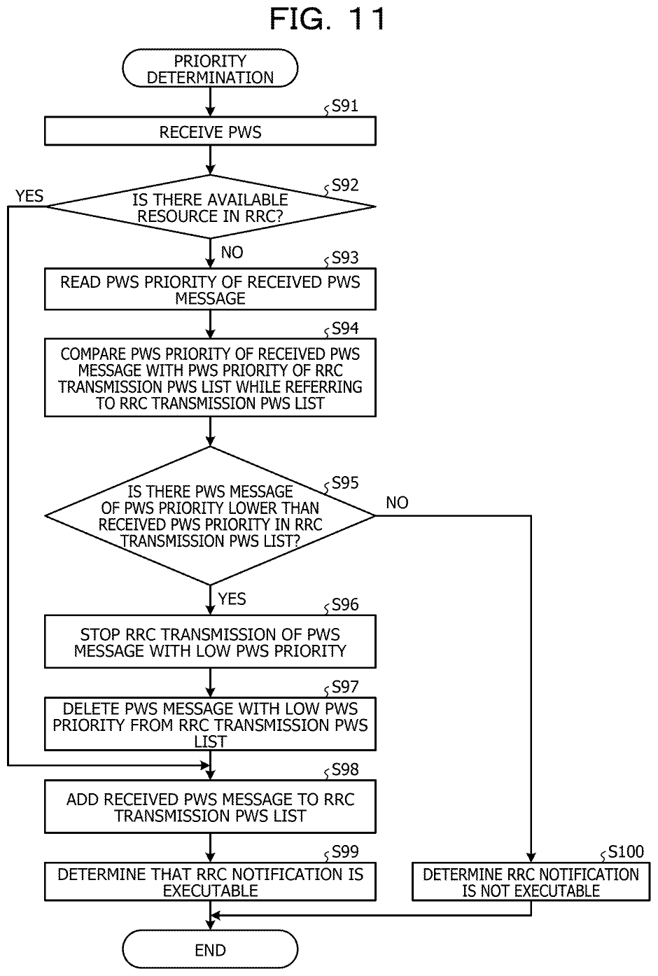

Next, FIGS. 10 and 11 are flowcharts for describing an example of an operation of the DU 20. First, FIG. 10 illustrates a processing procedure of the duplication determination of step S7 described above. The inter-CU-DU message transmission and reception unit 21 receives, from the CU 10, the processed PWS message to which the PWS identifier and the priority information are added by the CU 10 and on which the processing corresponding to the message type is performed (step S71).

The PWS message processing unit 24 reads the PWS identifier added to the received processed PWS message (step S72). The PWS message processing unit 24 checks whether or not there is the PWS identifier coinciding with the read PWS identifier while referring to the RRC transmission PWS list 26 (steps S73 to S74).

When there is the PWS identifier coinciding with the read PWS identifier in the RRC transmission PWS list 26 (Yes in step S74), the PWS message processing unit 24 determines that there are the duplicate messages (step S75). On the other hand, when there is no PWS identifier coinciding with the read PWS identifier in the RRC transmission PWS list 26 (No in step S74), the PWS message processing unit 24 determines that there are no duplicate messages (step S76).

FIG. 11 illustrates a processing procedure of the priority determination of step S9 described above. First, when the PWS message to be processed is received (step S91), the PWS message processing unit 24 checks whether or not there is the available resource in the radio section (step S92). When there is no available resource in the radio section (Yes in step S92), the PWS message processing unit 24 advances the processing to step S98. On the other hand, when there is no available resource in the radio section (No in step S92), the PWS message processing unit advances the processing to step S93.

In the processing of step S93, the PWS message processing unit 24 reads the PWS priority from the Priority Indicator added to the received PWS message processed by the CU 10. The PWS message processing unit 24 checks whether or not there is the PWS message with the PWS priority lower than the read PWS priority while referring to the RRC transmission PWS list 26 (steps S94 to S95).

When there is no PWS message with the PWS priority lower than the read PWS priority (No in step S95), the PWS message processing unit 24 determines that the transmission (RRC notification) of the message to the radio section is not executable (step S100).

On the other hand, when there is the PWS message with the PWS priority lower than the read PWS priority (Yes in step S95), the PWS message processing unit 24 stops the transmission (RRC transmission) of the PWS message with the PWS priority lower than the read PWS priority to the radio section (step S96). The PWS message processing unit 24 deletes the PWS message with the PWS priority lower than the read PWS priority from the RRC transmission PWS list 26 (step S97).

The PWS message processing unit 24 adds the received PWS message processed by the CU 10 to the RRC transmission PWS list 26 (step S98), and determines that the transmission (RRC notification) of the message to the radio section is executable (step S99).

As described above, according to the present embodiment, the CU 10 adds the PWS identifier for identifying the PWS message to the processed PWS message obtained by performing the processing corresponding to the message type of the PWS message on the PWS message received from the higher-level network. The CU 10 transmits the processed PWS message to which the PWS identifier is added to the DU 20.

In this case, the DU 20 may receive the processed PWS message obtained by adding the PWS identifier for identifying the PWS message to the PWS message transmitted from the higher-level network and performing the processing corresponding to the message type of the PWS message. The DU 20 may identify the processed PWS message by using the PWS identifier added to each of the plurality of received processed PWS messages.

Accordingly, for example, when the gNB 4 receives the PWS Cancel Request for giving the instruction to stop a part of the plurality of Write-Replace Warning Requests while receiving the plurality of Write-Replace Warning Requests, the DU 20 may specify the PWS message to be stopped. As stated above, the DU 20 that does not have a function of reading the information on the RRC level identifies the plurality of PWS messages, and may perform the processing.

The DU 20 may control the duplicate processed PWS messages among the plurality of received processed PWS messages. Accordingly, for example, the DU 20 performs the duplication determination of the plurality of received Write-Replace Warning Requests, and may suppress the transmission of the unnecessary message to the radio section.

According to the present embodiment, the CU 10 further adds, to the processed PWS message, the predetermined priority information for each PWS message which indicates the priority order in which the DU 20 transmits the message by using the radio link. In this case, the DU 20 may control the priority order in which the DU transmits the message by using the radio link by using the priority information added to the processed PWS message.

Accordingly, for example, the DU 20 may easily determine the priorities of the plurality of received Write-Replace Warning Requests without using the PWS identifier or cooperating with the O&M apparatus or the higher-level apparatus. As a result, the DU 20 may reliably transmit the high-priority message according to the resource of the radio section.

[Hardware Configuration]

The CU 10 and the DU 20 in the above-described embodiment may be achieved by, for example, the following hardware configuration. FIG. 13 illustrates a hardware configuration example of the CU 10 and the DU 20. As illustrated in FIG. 13, the CU 10 includes a processor 10a, a memory 10b, and a transfer path interface (IF) 10c. The processor 10a includes, for example, a central processing unit (CPU), a field-programmable gate array (FPGA), a digital signal processor (DSP), and the like. The memory 10b includes a random-access memory (RAM) such as, for example, a synchronous dynamic random-access memory (SDRAM), a read-only memory (ROM), and a flash memory. The transfer path IF 10c is a circuit that communicates with other apparatuses such as the AMF 3 and the DU 20. The inter-AMF-CU message transmission and reception unit 11, the message determination unit 12, the AMF-CU and CU-DU message conversion unit 13, the PWS message processing unit 14, and the inter-CU-DU message transmission and reception unit 15 are achieved by, for example, the processor 10a.

The DU 20 includes a processor 20a, a memory 20b, a transfer path interface (IF) 20c, and a radio transfer IF 20d. The processor 20a includes, for example, a central processing unit (CPU), a field programmable gate array (FPGA), a digital signal processor (DSP), and the like. The memory 20b includes a RAM such as, for example, a synchronous dynamic random-access memory (SDRAM), a read-only memory (ROM), and a flash memory. The transfer path IF 20c is a circuit that communicates with another apparatus such as the CU 10. The radio transfer IF 20d is a circuit that performs radio communication with the UE 5 via an antenna. The inter-CU-DU message transmission and reception unit 21, the message determination unit 22, the CU-DU and DU-RRC message conversion unit 23, the PWS message processing unit 24, and the inter-DU-RRC message transmission and reception unit 25 are achieved by, for example, the processor 20a.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A communication apparatus, comprising:
a memory; and
a processor circuit coupled to the memory, the processor circuit being configured to perform processing, the processing including:
executing an addition processing configured to add identification information for identifying report information to processed report information obtained by performing processing corresponding to a type of the report information on the report information received from a higher-level network; and
executing a transmission processing configured to transmit the processed report information to which the identification information is added by the addition unit to a second communication apparatus coupled to a radio link.

2. The communication apparatus according to claim 1, wherein the addition processing is configured to further add predetermined priority information for each report information indicating a priority order in which the second communication apparatus transmits the report information by using the radio link to the processed report information.

3. A communication apparatus, comprising:
a memory; and
a processor circuit coupled to the memory, the processor being configured to perform processing, the processing including:
executing a reception processing configured to receive processed report information obtained by adding identification information for identifying report information to the report information transmitted from a higher-level network and performing processing corresponding to a type of the report information; and
executing an identification processing configured to identify the processed report information by using the identification information added to each of a plurality of pieces of the received processed report information.

4. The communication apparatus according to claim 3, wherein the identification processing is configured to control pieces of duplicate processed report information among the plurality of pieces of received processed report information.

5. The communication apparatus according to claim 3, wherein the identification processing is configured to further control a priority order in which the report information is transmitted by using a radio link by using predetermined priority information for each report information which is added to the processed report information and indicates the priority order in which the report information is transmitted by using the radio link.

6. A radio communication system, comprising:
a first communication apparatus; and
a second communication apparatus,
wherein the first communication apparatus is configured to perform processing, the processing including:
executing an addition processing configured to add identification information for identifying report information to processed report information obtained by performing processing corresponding to a type of the report information on the report information received from a higher-level network; and
executing a transmission processing configured to transmit the processed report information to which the identification information is added by the addition unit to the second communication apparatus coupled to a radio link, and
the second communication apparatus is configured to perform processing, the processing including:
executing a reception processing configured to receive the processed report information to which the identification information is added and which is transmitted from the first communication apparatus; and
executing an identification processing configured to identify the processed report information by using the identification information added to each of a plurality of pieces of the received processed report information.
